(19) United States
(12) Patent Application Publication
(10) Pub. No.: US 2010/0211987 A1
(43) Pub. Date: Aug. 19, 2010

(54) VIDEO DEDUPLICATION, CACHE, AND VIRTUAL PRIVATE CONTENT DELIVERY NETWORK

(75) Inventor: Randy Yen-pang Chou, San Jose, CA (US)

Correspondence Address: BLAKELY SOKOLOFF TAYLOR & ZAFMAN LLP, 1279 OAKMEAD PARKWAY, SUNNYVALE, CA, 94085-4040, US

(73) Assignee: PIXEL8 NETWORKS, INC., Menlo Park, CA (US)

(21) Appl. No.: 12/389,331

(22) Filed: Feb. 19, 2009

(51) Int. Cl. H04N 7/173; H04N 7/12

(52) U.S. Cl. 725/119; 375/240.01

(57) ABSTRACT

Embodiments of systems and methods of video deduplication, cache, and virtual private content delivery network are described herein. In one embodiment of the invention, the bandwidth traffic between an access module and a signal module may be reduced by making a determination at the signal module that the requested video data is redundant. According to another embodiment of the invention, the determination of whether the requested video data is redundant is performed at the access module. In one embodiment, a cache module and a signal module are used to decrease bandwidth usage over the Internet. In another embodiment, the cache module makes the determination of whether the requested data is redundant to efficiently route data. In one embodiment, a virtual private content delivery network is implemented to allow for private data to be securely sent over a network systems such as a content delivery network or cloud computing services or a cache. In yet another embodiment, bandwidth usage is curtailed using a virtual private content delivery network that backs up data which originates from the Internet on a signal module.

### FIELD

Embodiments of the invention relate to video deduplication, cache and virtual private content delivery network.

### BACKGROUND

Presently, the amount of video data being transmitted and received over the Internet greatly accounts for increasing bandwidth usage. Often, the same or a portion of the same video is being transmitted and received by different users. For example, during President Obama's inauguration, CNN reported that it provided more than 21.3 million video streams of the event. Given that bandwidth requirements on the Internet are doubling every year without corresponding cost reductions, a mechanism that curtail the sending and receiving of redundant video data would provide cost savings to the network providers and perhaps their customers.

Solving the issue of redundant video data is difficult in that it faces two unique problems. First, video data is already deduplicated such that it is difficult to further deduplicate the data since most video is compressed in a manner that used deduplication techniques such as motion estimation. Second, video data is hard to cache. For example, certain video sharing websites obfuscate video data and modify up to 5% of the video per download to include customized metadata and advertisements. Further, certain websites that offer commercial-supported video, such as Hulu for example, use streaming video which is treated as dynamic data which is not cacheable.

Additionally, while general consumers have the benefit of utilizing content distribution networks (CDNs) which are massive network backbones built for carrying large data such as Internet video, large enterprises do not use CDNs for their private data transfers over the Internet due to a lack of inherent security associated with the CDNs. Further, the enterprise's private network cannot achieve the reach, coverage and cost discounts of a typical CDN.

Moreover, data being backed up is also a significant cause of the increasing bandwidth usage. Generally, half of the data being backed up consist of files downloaded from the Internet. For example, large data being backed up originating from the Internet include videos, DVD ISOs, Windows update files, installation programs, virus scanning databases, etc.

### SUMMARY

Embodiments of methods and systems for video deduplication, cache, and virtual private content distribution network are described.

According to one embodiment of the invention, the bandwidth traffic between an access module and a signal module may be reduced by making a determination at the signal module that the requested video data is redundant. In this embodiment of the invention, a method for routing video data starts by receiving a request for a video data from an electronic device. A unique identification included in the video data is then extracted and a hash value of the unique identification is computed. The hash value of the unique identification is then compared with a plurality of stored hash values. Each of the plurality of stored hash values identifies video data that has been previously transmitted to the electronic device. If the hash value of the unique identification matches one of the plurality of stored hash values, a video display signal is transmitted which provides information for the electronic device to locate the video data and avoid a repeated transmission of the video data.

According to another embodiment of the invention, the bandwidth traffic between an access module and a signal module may be reduced by making a determination at the access module that the requested video data is redundant. In this embodiment of the invention, a method for efficiently routing video data from a signal module starts by transmitting a request for a video data to the signal module and receiving the video data from the signal module. A unique identification of the video data is then extracted and a hash value of the unique identification is computed. The hash value of the unique identification is then compared with a plurality of stored hash values. If the hash value of the unique identification matches one of the plurality of stored hash values, a stop transmission signal is transmitted to the signal module. The stop transmission signal signals to the signal module to stop transmitting the video data since the video data is currently stored within the access module.

In yet another embodiment of the invention, a cache module and a signal module are used to decrease bandwidth usage over the Internet. Herein, a system comprises a signal module to receive a requested video data having a unique identification from an origin server and a cache module coupled to the signal module. The signal module includes a signal module (SM) hash compute module to compute a hash value of the unique identification of the requested video data, a SM cache to store a plurality of previously requested video data, a SM hash storage module to store hash values of the unique identifications of the previously requested video data stored in the SM cache, and a SM hash compare module to compare the hash value of the unique identification of the requested video data to the hash values stored in the SM hash storage module, and to generate a transmit signal if the hash value of the unique identification of the requested video data does not match one of the hash values stored in the SM hash storage module. The cache module coupled to the signal module includes a cache module (CM) cache to store the requested video data and previously requested video data received from the signal module, a CM hash compute module to compute the hash values of the unique identification of requested video data and the previously requested video data stored in the CM cache, and a CM hash storage to store the hash values computed in the CM hash compute module.

In another embodiment of the invention, a cache module makes the determination of whether the requested data is redundant to efficiently route data. According to this embodiment, a system comprises a plurality of clients including a first client and a second client and a cache module. The first client sends a request for a first requested video data and a second client sends a request for a second requested video data. The first and second requested video data each have a unique identification. The cache module receives the requests from the first and second clients and also receives the first and a second requested video data from an external source. The cache module includes a CM cache, a CM hash storage, a CM hash compute module, a CM hash compare module, and a CM stream sampling compare module. The CM cache stores a plurality of previously requested video data. Each of the plurality of previously requested video data having unique identifications. The CM hash storage stores hash values of the unique identifications of the plurality of previously requested video data. The CM hash compute module computes a first hash value which is the hash value of the unique identification of first requested video data. The CM hash compare module compares the first hash value to the hash values stored in the CM hash storage and generates a transmit signal if the first hash value does not match one of the hash values stored in the CM hash storage module. The CM stream sampling compare module performs a comparison operation and generates a stop signal if the comparison operation indicates a match at a number of entry points. The comparison operation includes: (i) hashing headers of the first requested video data and the second requested video data at a number of entry points to obtain a number of hash results for the first requested video data and a number of hash results for the second requested video data, (ii) comparing for each of the number of entry points hash result for the first requested video data to the corresponding hash result for the second requested video data, and (iii) determining if there is a match between the hash results at each of the number of entry points.

In one embodiment, a virtual private content delivery network is implemented to allow for private data to be securely sent over a network system such as a content delivery network or cloud computing services or a cache. In this embodiment, a method of efficiently and securely sending data starts by receiving a request for data from an access module and encrypting the data. The time delay of a network system which is the length of time before the access module starts downloading the encrypted data from the network system, is determined. The start portion of the encrypted data is then transmitted to the access module via a secure control channel. The start portion of the encrypted data corresponds to an amount of the data that would be transmitted over the network system during the time delay. The remainder portion of the encrypted data is then transmitted to the access module via the network system. The remainder portion of the encrypted data is a portion equal to the encrypted data excluding the start portion.

In yet another embodiment, bandwidth usage is curtailed using a virtual private content delivery network that backs up data which originates from the Internet on a signal module. In this embodiment, a system comprises a back-up storage device, an origin server, an access module coupled to the back-up storage device, and a signal module coupled to the origin server. The access module is used to scan a first data being backed up the back-up storage device, the first data having a first unique identification, compute a hash value of the first unique identification, compare the hash value of the first unique identification to a plurality of hash values stored in the access module, and transmit the hash value of the first unique identification if the hash value of the first unique identification does not match one of the plurality of stored hash values. The signal module is used to receive the hash value of the first unique identification from the access module, compare the hash value of the first unique identification to a plurality of hash values stored in the signal module, download the first data from the origin server and store the first data in the signal module if the hash value of the first unique identification does not match one of the plurality of hash values stored in the signal module, and receive data information associated with the first data from the access module.

The above summary does not include an exhaustive list of all aspects or embodiments of the present invention. It is contemplated that the invention includes all systems and methods that can be practiced from all suitable combinations of the various aspects summarized above, as well as those disclosed in the Detailed Description below and particularly pointed out in the claims filed with the application. Such combinations may have particular advantages not specifically recited in the above summary.

### BRIEF DESCRIPTION OF THE DRAWINGS

The embodiments of the invention are illustrated by way of example and not by way of limitation in the figures of the accompanying drawings in which like references indicate similar elements. In the drawings:

FIG. 1A is an exemplary block diagram of a system in which one embodiment of the invention may be implemented.

FIG. 1B is an exemplary block diagram of a portion of the system in FIG. 1A in which one embodiment of the invention may be implemented.

FIG. 1C is an exemplary block diagram of a portion of the system in FIG. 1A in which another embodiment of the invention may be implemented.

FIG. 2A is an exemplary block diagram of a system in which one embodiment of the invention may be implemented.

FIG. 2B is an exemplary block diagram of a system in which another embodiment of the invention may be implemented.

FIG. 3 is an exemplary block diagram of a system in which one embodiment of the Virtual Private Content Delivery Network may be implemented to securely transfer data.

FIG. 4 is an exemplary block diagram of a system in which another embodiment of the Virtual Private Content Delivery Network may be implemented to back up data.

### DETAILED DESCRIPTION

In the following description, numerous specific details are set forth. However, it is understood that embodiments of the invention may be practiced without these specific details. In other instances, well-known circuits, structures, and techniques have not been shown to avoid obscuring the understanding of this description.

Herein, the terms “logic” and “module” are generally defined as hardware and/or software configured to perform one or more functions. However, the logic is a component of a module. For instance, the logic may be software or one or more integrated circuits, semiconductor devices, circuit boards, combinatorial logic or the like. A module may be any networking equipment (e.g., router, bridge, brouter, etc.), an integrated circuit or server, personal computer, main frame, or software executed therein.

“Software” is generally describes as a series of operations that are performed by executing preloaded instructions or executing instructions provided by an application, an applet, or even a routine. The software may be executed by any processing device including, but not limited or restricted to a microprocessor, a digital signal processor, an application specific integrated circuit, a microcontroller, a state machine, or any type of programmable logic array. The software may be stored in any type of machine readable medium such as a programmable electronic circuit, a semiconductor memory device such as volatile memory (e.g., random access memory, etc.) and/or non-volatile memory such as any type of read-only memory (ROM) or flash memory, a portable storage medium (e.g., hard drive, optical disc drive, digital tape drive), or the like.

The following description is the divided into four parts. Part I describes systems and methods for efficiently routing data between an access module and a signal module. Part II describes systems for efficiently routing data using a cache module. Part III describes a method of securely sending private data over a network device using virtual private content delivery network, and Part IV describes a method of backing up data that originates from the Internet on a signal module in a virtual private content delivery network.

### Part I: Systems and Methods for Efficiently Routing Data Between an Access Module and a Signal Module

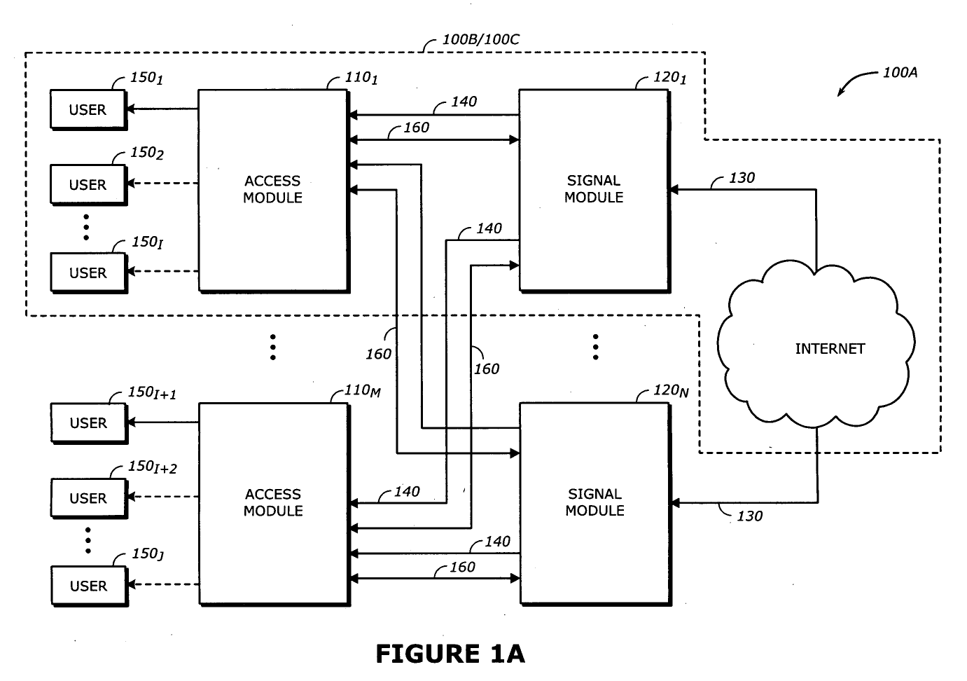

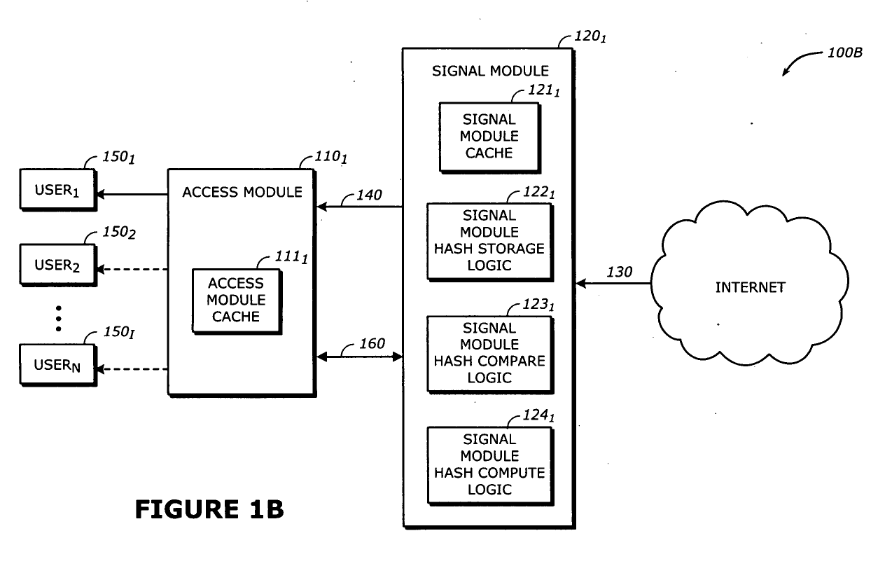

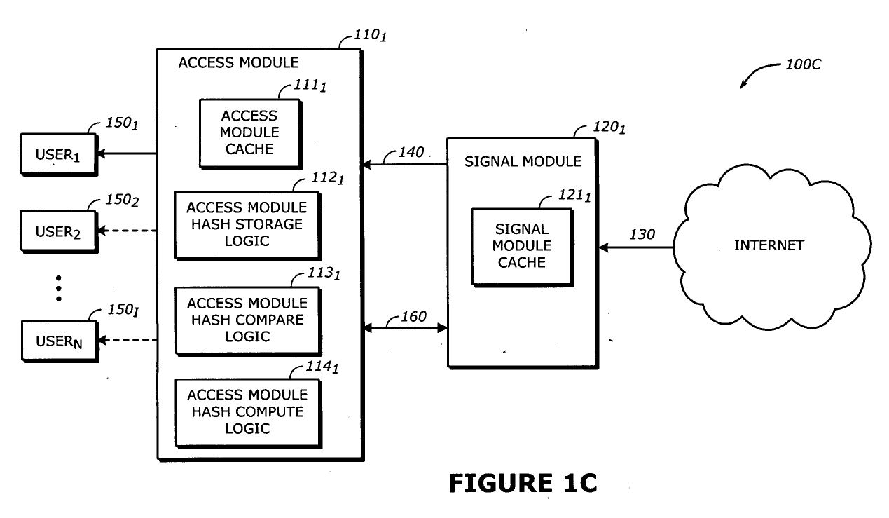

FIG. 1A shows an exemplary block diagram of a system in which an embodiment of the invention may be implemented. System 100A comprises a plurality of access modules 110₁-110_{M}, a plurality of signal modules 120₁-120_{N}, and a plurality of user modules (150₁-150_{I} . . . 150_{I+1}-150_{J}) (where I, J, M, N≧1). Each access module 120₁-120_{N} is coupled to a number of user modules 150₁-150_{I} and each of the plurality of signal modules 120₁-120_{N} is coupled to the Internet via a transmission medium 130. Each of the plurality of access modules 110₁-110_{M} are further coupled to each of the plurality of signal modules 120₁-120_{N} via transmission mediums 140 and 160. The transmission mediums 130 and 140 operate as communication pathways for data whereas the transmission medium 160 operates as a communication pathway for control signals. The transmission mediums 130, 140, 160 may include, but is not limited to electrical wires, optical fiber, cable, a wireless link established by wireless signaling circuitry, or the like.

FIG. 1B shows an exemplary block diagram of a system 100B in which an embodiment of the invention may be implemented. The system 100B is a portion of the system 100A illustrated in FIG. 1 and is merely one of multiple embodiments of the invention.

In this embodiment of the invention, system 100B comprises an access module 110₁ coupled to a signal module 120₁ and a plurality of user modules 150₁-150_{I}. The access module 110₁ includes an access module cache memory 111₁ and the signal module 120₁ includes a signal module cache memory 121₁, a signal module hash storage logic 122₁, a signal module hash compare logic 123₁ and a signal module hash compute logic 124₁.

By way of illustration, the access module 110₁ may, for example, be located at one of the dorms at a university and the signal module 120₁ may be located at the communication center of the university such as a server room. In this example, the bandwidth on transmission medium 140 which couples the access module 110₁ to the signal module 120₁ is expensive to increase since additional physical cables and/or equipment would need to be installed. Therefore, in an effort to reduce the bandwidth traffic on transmission medium 140, a determination is made at the signal module 120₁ whether or not the requested video data is redundant.

According to this embodiment of the invention, the signal module 120₁ receives a request for a video data from the access module 110₁. The signal module hash compute logic 124₁ extracts a unique identification included in the video data and computes a hash value of the unique identification. Thereafter, the signal module hash compare logic 123₁ compares the hash value of the unique identification with a plurality of hash values stored in the signal module hash storage logic 122₁. Each of the plurality of stored hash values identifies video data that has been previously transmitted to the access module 110₁.

If the signal module hash compare logic 123₁ determines that the hash value of the unique identification matches one of the plurality of stored hash values, a video recovery signal is transmitted from signal module 120₁ to the access module 110₁ via transmission line 160. The video recovery signal provides information for access module 110₁ to locate the video data in the access module cache 111₁ and avoid a repeated transmission of the video data over transmission medium 140. The video recovery signal may include the hash value of the unique identification. Upon receiving the video recovery signal from the signal module 120₁, the access module 110₁ identifies a previously stored video data corresponding to the hash value of the unique identification and transmits the previously stored video data to a user device 150₁.

If the signal module hash compare logic 123₁ determines that the hash value of the unique identification does not match one of the plurality of hash values stored in the signal module hash storage logic 122₁, the signal module 120₁ transmits the video data to the access module 110₁ via transmission medium 140. The access module 110₁ then may transmit the video data to the user module 150₁ that requested the video data. To update the contents of the signal module hash storage logic 122₁ and the signal module cache 121₁, the signal module 120₁ may store the hash value of the unique identification and the video data in the signal module hash storage logic 122₁ and the signal module cache 121₁, respectively.

In one embodiment of the invention, the signal module 120₁ may receive a flush signal from the access module 110₁ via transmission medium 160. The flush signal may cause the signal module 120₁ to delete a particular hash value from the signal module hash storage logic 122₁, where the particular hash value corresponds to the unique identification of a video data being deleted from the access module cache 111₁. More specifically, upon receipt of the flush signal, the signal module 120₁ may delete the hash value from the plurality of hashes stored in the signal module hash storage logic 122₁ (hereafter referred to as the “flushed hash value”). The signal module 120₁ may also delete the video data stored in the signal module cache 121₁ which corresponds to the flushed hash value.

FIG. 1C shows exemplary block diagram of a system 100C in which another embodiment of the invention may be implemented. As an alternative embodiment to system 100B, system 100C reduces the bandwidth traffic on transmission medium 140 by making a determination at the access module 110₁ that the requested video data is redundant.

As described above for system 100B, the system 100C comprises an access module 110₁ coupled to a signal module 120₁ and a plurality of user modules 150₁-150_{I} (I≧1). However, in this embodiment, the access module 110₁ includes an access module cache 111₁, an access module hash storage logic 112₁, an access module hash compare logic 113₁ and an access module hash compute logic 114₁ and the signal module 120₁ includes a signal module cache 121₁.

According to this embodiment of the invention, the access module 110₁ transmits a request for video data to the signal module 120₁ and receives the video data from the signal module 120₁. The access module hash compute logic 114₁ extracts a unique identification of the video data and computes a hash value of the unique identification. The access module hash compare logic 113₁ then compares the hash value of the unique identification with a plurality of hash values stored in the access module hash storage logic 112₁.

If the access module hash compare logic 113₁ determines that the hash value of the unique identification matches one of the plurality of stored hash values, the access module 110₁ transmits a stop transmission signal to the signal module 120₁. The stop transmission signal indicates to the signal module 120₁ to stop transmitting the video data since the video data is currently stored within the access module cache 111₁. Thereafter, the access module hash compare logic 113₁ may then compare the hash value of the unique identification with a hash value associated with the previously stored video data to identify a previously stored video data that corresponds to the video data. Alternatively, the hash value of the unique identification may be used as an index to a look-up table in order to recover the memory location of the previously stored video data. The access module 110₁ may then transmit the previously stored video data to the user module 150₁ that requested the video data.

If the access module hash compare logic 113₁ determines that the hash value of the unique identification fails to match any of the plurality of stored hash values, the access module 110₁ does not perform any actions to discontinue transmission of the video data, but rather, stores the video data received from the signal module 120₁ in the access module cache 111₁ and transmits the video data to the user module 150₁ that requested the video data. The signal module 120₁ may also store the video data in the signal module cache 121₁.

In both system 100B and 100C, as an example, the video data may be in an MP4 format and the unique identification of video data is a MOOV atom. The MOOV atom may include elements such as the location of the start of the video, the frame rate, the resolution, and the key frame offset. Since the order of the elements in the MOOV atom may differ from one video data to another, in one embodiment, the signal module hash compute logic 124₁ in system 100B and the access module hash compute logic 114₁ in system 100C may reorder the elements in the MOOV atom and hash the reordered elements in order to compute the hash value.

### Part II: Systems for Efficiently Routing Data Using a Cache Module

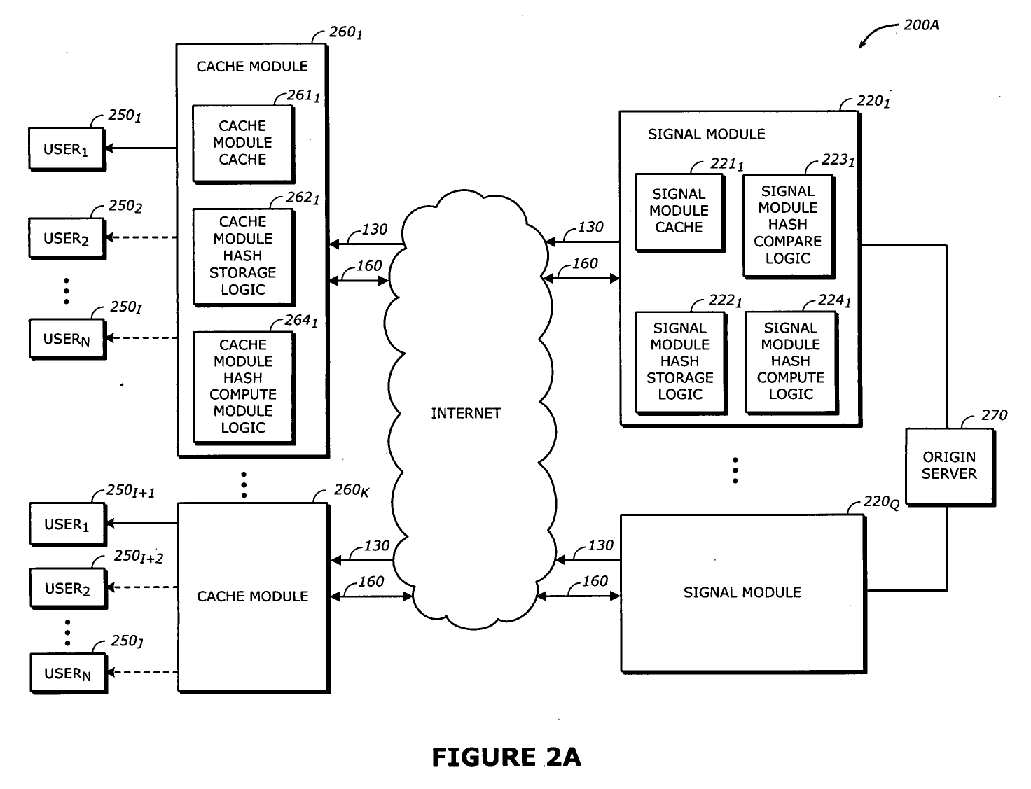

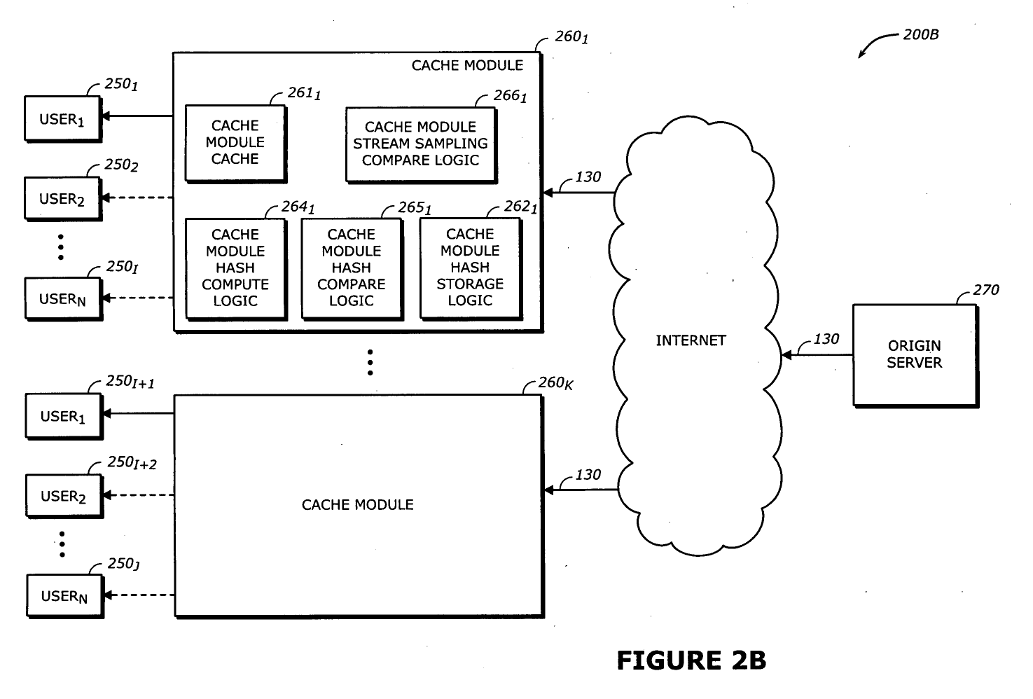

FIG. 2A shows an exemplary block diagram of a system 200A in which an embodiment of the invention may be implemented. In this embodiment, a system comprises a plurality of signal modules 220₁-220_{Q} coupled to an origin server 270, a plurality of cache modules 260₁-260_{K} which are coupled to a plurality of user modules 250₁-250_{I} . . . 250_{I+1}-250_{J} (where I, J, K, Q≧1). Each of the plurality of cache modules 260₁-260_{K} is coupled to the each of the plurality of signal module 220₁-220_{Q} and the Internet via a transmission medium 130 for data and a transmission medium 160 for control signals.

By way of illustration, in this embodiment, the cache module 260₁ may, for example, be located near the plurality of user modules 250₁-250_{I} and the plurality of signal modules 220₁-220_{Q} are located at Internet provider's server center (e.g., Cox communications or Time Warner's server center). If user 250₁ and user 250₂ are both downloading the same video content from a content owner over the Internet, the redundant video data unnecessarily utilizes bandwidth. According to this embodiment of the invention, the signal module 220₁ determines whether the requested data is redundant to reduce the amount of redundant data being sent over the Internet.

In this embodiment, each of the signal modules 220₁-220_{Q} (e.g., signal module 220₁) includes a signal module cache 221₁, a signal module hash storage logic 222₁, a signal module hash compute logic 224₁, and a signal module hash compare logic 223ⱼ and each of the cache modules 260₁-260_{K} (e.g., cache module 260₁) includes a cache module cache 261₁, a cache module hash compute logic 264₁, and a cache module hash storage logic 262₁.

In this embodiment, one of the plurality of user modules 250₁ may send the request for video data to cache module 260₁. The cache module 260₁ may send the request for video data to the signal module 220₁ via the transmission medium 160. The signal module 220₁ then receives the requested video data having a unique identification from the origin server 270. The signal module hash compute logic 224₁ computes a hash value of the unique identification of the requested video data and the signal module hash compare logic 223₁ compares the hash value of the unique identification of the requested video data to the hash values stored in the signal module hash storage logic 222₁. The signal module hash storage logic 222₁ stores hash values of the unique identifications of the previously requested video data which are stored in the signal module cache 221₁.

If the hash value of the unique identification of the requested video data does not match one of the hash values stored in the signal module hash storage logic 222₁, the signal module hash compare logic 223₁ generates a transmit signal that indicates to the signal module 220₁ to transmit the requested video data to the cache module 260₁ because the requested video data is a new transmission to the cache module 260₁. In one embodiment of the invention, the storage module cache 221₁ may store the requested video data and the storage module hash storage logic 222₁ may store the hash value of the unique identification of the requested video data in order to update the storage module cache 221₁ and the storage module hash storage logic 222₁. Upon receiving the requested video data from the signal module 220₁, the cache module 260₁ may transmit requested video data the user module 250₁ that requested the video data.

In one embodiment, the cache module cache 261₁, which stores previously requested video data received from the plurality of signal modules 220₁, stores the requested video data. In that embodiment of the invention, the cache module hash compute logic 264₁, which computes the hash values of the previously requested video data stored in the cache module cache 261₁, computes the hash value of the unique identification of the requested video data to be stored in the cache module hash storage logic 262₁. The cache module hash storage logic 262₁ stores the hash values computed in the cache module hash compute logic 264₁.

If the hash value of the unique identification of the requested video data matches one of the hash values stored in the signal module hash storage logic 222₁, the signal module hash compare logic 223₁ generates a video display signal to the cache module 260₁. The video display signal indicates to the cache module 220₁ to locate the requested video data in the cache module cache 261₁ because the requested video data is a repeated transmission to the cache module 260₁. The video display signal may include the hash of the unique identification of the requested video data. Upon receiving the video display signal, the cache module 260₁ may identify a previously stored video data corresponding to the hash of the unique identification, and transmit the previously stored video data corresponding to the hash of the unique identification to the user module 250₁ that requested the video data.

In one embodiment, the cache module 260₁ may transmit a flush signal to the signal module 220₁ via transmission medium 160. The flush signal may include a flushed hash value, which is the hash value of the unique identification of a video data being deleted from the cache module cache 261₁. Upon receipt of the flush signal, the signal module 220₁ may delete the hash value from the plurality of hashes stored in the signal module hash storage logic 222₁ which corresponds to the flushed hash value. The signal module 220₁ may also delete the video data stored in the signal module cache 221₁ which corresponds to the hash value being deleted from the signal module hash storage logic 222₁.

As in systems 100B and 100C, the video data in system 200A may be in an MP4 format and the unique identification of video data is a MOOV atom. The MOOV atom may include elements such as the location of the start of the video, the frame rate, the resolution, and the key frame offset. As discussed above, given the differing order of the elements in each video data, in one embodiment, the signal module hash compute logic 224₁ and the cache module hash compute logic 264₁ may reorder the elements in the MOOV atom and hash the reordered elements to compute the hash of the unique identification.

In system 200A, the video data may also be in a Flash Video (FLV) format and include a FLV header. Video data in FLV format may or may not include a script tag with indexing information. For video data that include a script tag with indexing information, the unique identification of the data is the indexing information. Accordingly, the signal module hash compute logic 224₁ and the cache module hash compute logic 264₁ may hash the indexing information to compute the hash of the unique identification. For video data that does not include a script tag with indexing information, the video data may include a video index which is the unique identification of the data. For this type of video data, the signal module hash compute logic 224₁ and the cache module hash compute logic 264₁ may compute the hash of the unique identification by selecting a plurality of access points the video index, and by hashing each of the plurality of access points to obtain a plurality of hash values. In one embodiment of the invention, the signal module hash compare logic 223₁ compares each of the plurality of hash values to the corresponding hash value stored in the signal module hash storage logic 222₁. If each of the plurality of hash values matches each corresponding hash value stored in the signal module hash storage logic 222₁, the signal module hash compare logic 223₁ generates the transmit signal that indicates to the signal module 220₁ to transmit the requested video data to the cache module 260₁ as discussed above.

In system 200A, the video data may also be in a Real Time Streaming Protocol (RTSP) format. In this format, the unique identification is an Advanced Systems Format (ASF) header and Globally Unique Identifier (GUID) which are included in the video data. In this format, the signal module hash compute logic 224₁ and the cache module hash compute logic 264₁ may hash the ASF header and the GUID to compute the hash of the unique identification.

The video data in system 200A may also be in a Real Time Messaging Protocol (RTMP) format. For video data in the RTMP format, the unique identification is a video header which included in the video data. Accordingly, the signal module hash compute logic 224₁ and the cache module hash compute logic 264₁ may compute the hash of the unique identification of the video data in RTMP format by selecting a plurality of access points the video header and by hashing each of the plurality of access points to obtain a plurality of hash values. In one embodiment, the signal module hash compare logic 223₁ then compares each of the plurality of hash values to the corresponding hash value stored in the signal module hash storage 222₁. If each of the plurality of hash values matches each corresponding hash value stored in the signal module hash storage 222₁, the signal module hash compare logic 223₁ generates the transmit signal that indicates to the signal module 220₁ to transmit the requested video data to the cache module 260₁ as discussed above.

FIG. 2B shows an exemplary block diagram of a system 200B in which an embodiment of the invention may be implemented. In this embodiment, a system comprises a plurality of user modules 250₁-250_{I} . . . 250_{I+1}-250_{J} which are coupled to a plurality of cache modules 260₁-260_{K}. Each of the plurality of cache modules 260₁-260_{K} is coupled to an origin server 270 over the Internet via a transmission medium 130 for data (I, J, K≧1).

By way of illustration, as in system 200A, in this embodiment of system 200B, the cache module 260₁ may, for example, be located near the plurality of user modules 250₁-250_{I} and origin server is located at Internet provider's server center (e.g., Cox communications or Time Warner's server center). In this embodiment of the invention, the cache modules 260₁-260_{K} make a determination of whether the requested data is redundant to efficiently route data and reduce the amount of redundant data being sent from the origin server 270 over the Internet.

In one embodiment, each of the cache modules 260₁-260_{K} (e.g., cache module 260₁) includes a cache module cache 261₁, a cache module hash storage logic 262₂, a cache module hash compute logic 264₁, a cache module hash compare logic 265₁ and a cache module stream sampling compare logic 266₁.

In this embodiment, the cache module cache 261₁ stores a plurality of previously requested video data. Each of the plurality of previously requested video data having unique identifications. The cache module hash storage logic 262₁ stores hash values of the unique identifications of the plurality of previously requested video data.

In one embodiment, one of the plurality of user modules (e.g. user module 250₁) may send a request for a first requested video data to cache module 260₁. The first requested video data includes a unique identification. The cache module hash compute logic 264₁ extracts the unique identification and computes a first hash value which is the hash value of the unique identification of first requested video data. The cache module hash compare logic 265₁ compares the first hash value to the hash values stored in the cache module hash storage logic 262₁.

If the first hash value does not match one of the hash values stored in the cache module hash storage logic 262₁, the cache module hash compare logic 265₁ generates a transmit signal that indicates to the cache module 260₁ to obtain the first requested video data from the origin server 270 and transmit the first requested video data to the first user module 250₁ that requested the video data. In one embodiment, the cache module cache 261₁ may store the first requested video data and the cache module hash storage logic 262₁ may store the first hash value in order to update the cache module cache 261₁ and the cache module hash storage logic 262₁.

If the first hash value matches one of the hash values stored in the cache module hash storage logic 262₁, the cache module hash compare logic 265₁ generates a video display signal that indicates to the cache module 260₁ that the first requested data is redundant and may be located in the cache module cache 261₁. Accordingly, a repeated transmission of the first requested data from the origin server 270 is avoided. The video display signal may include the hash value of the unique identification. Upon receiving the video display signal, the cache module 260₁ identifies a previously stored video data corresponding to the first hash value and transmits the previously stored video data corresponding to the first hash value to the first user device 250₁ that requested the first requested video data.

Similar to the systems described above, in system 200B, the first requested video data may be in a MP4 format. Accordingly, the first requested video data may include a first MOOV atom which is the unique identification. In this embodiment of the invention, the cache module compute logic 264₁ computes the first hash value by reordering elements in the first MOOV atom and hashing the reordered elements.

As above, the first requested video data may be in a FLV format and include a FLV header. For video data in FLV format that include a script tag with indexing information, the unique identification of the first requested video data is the first indexing information. Accordingly, the cache module compute logic 264₁ computes the first hash value by hashing the first indexing information. For video data in FLV format that does not include a script tag with indexing information, the first requested video data in FLV format may include a first index which is the unique identification. For this type of video data, the cache module compute logic 264₁ may compute the first hash value by selecting a plurality of access points in the first index, and by hashing each of the plurality of access points to obtain a plurality of hash values.

In one embodiment, the cache module hash compare logic 265₁ compares each of the plurality of hash values to the corresponding hash value stored in the cache module hash storage module 262₁. If each of the plurality of hash values matches each corresponding hash value stored in the cache module hash storage logic 262₁, the cache module hash compare logic 265₁ generates the transmit signal which indicates to the cache module 260₁ to obtain the first requested video data from the origin server 270 and transmit the first requested video data to the first user module 250₁ that requested the video data as discussed above.

In one embodiment, the first requested video data is in a RTSP format and the unique identification of the data is an ASF header and GUID which are included in the first requested video data. In this embodiment, the cache module compute logic 264₁ may hash the ASF header and the GUID to compute the first hash value.

In another embodiment, two of the plurality of user modules 250₁ and 250₂ may send a first request for video data and a second request for video data to cache module 260₁. The first and second requests for video data may each include a unique identification. In one embodiment, the video data may be in a RTMP format and, as above, the unique identification is the header included in the video data. The cache module 260₁ receives the first and a second requested video data from the origin server 270.

In one embodiment, the cache module stream sampling compare logic 266₁ performs a comparison operation to determine if the first and second requested video data are redundant. First, in this comparison operation, the cache module stream sampling compare logic 266₁ hashes the headers of the first requested video data and the second requested video data at a number of entry points to obtain a number of hash results for the first requested video data and a number of hash results for the second requested video data. Second, for each of the number of entry points, the cache module stream sampling compare logic 266₁ compares the hash result for the first requested video data to the corresponding hash result for the second requested video data. Third, the cache module stream sampling compare logic 266₁ determines if there is a match between the hash results at each of the number of entry points. If it is determined that there is a match, the cache module stream sampling compare logic 266₁ generates a stop signal that indicates to the cache module 260₁ that the first and second requested video data are redundant. Upon receipt of the stop signal, the cache module 260₁ signals to the origin server 270 to stop transmitting the second requested video data. Accordingly, the cache module 260₁ stops transmitting the second requested video data to the second user module 250₂ and transmits the first requested video data to both the first user module 250₁ and the second user module 250₂.

### Part III: Method of Securely Sending Private Data Over a Network Device Using a VPCDN

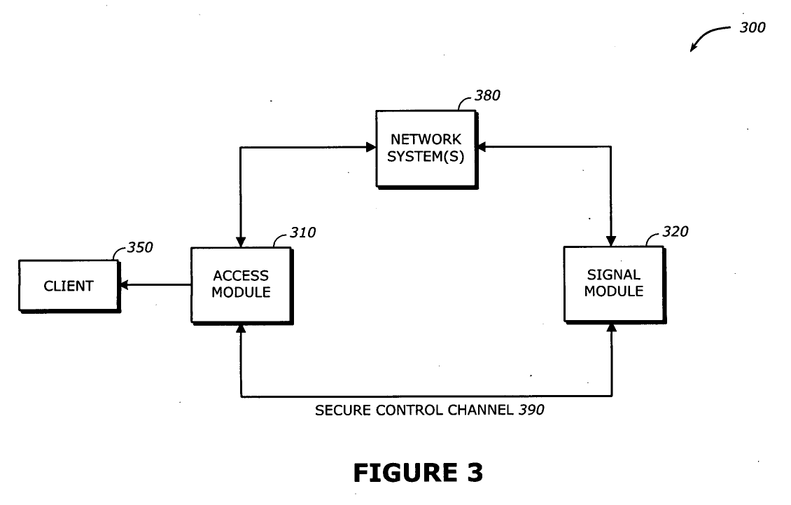

FIG. 3 shows an exemplary block diagram of a system 300 in which one embodiment of the Virtual Private Content Delivery Network (VPCDN) may be implemented to securely transfer data. As discussed above, large enterprises do not use systems such as CDNs for their private transfers over the Internet due to a lack of inherent security. System 300 allows for these large enterprises, which have offices in various locations throughout the world, to make use of network systems such as CDNs and cloud computing devices to securely and efficiently transfer their private data.

The VPCDN provides a number of advantages: (i) one and only one copy ever leaves the signal module at the corporate headquarters for example; (ii) security keys solely at the access and signal module within enterprise for example such that these security keys are not available to the network system(s) as defined below; and (iii) the device at the access module can be diskless. Moreover, the enterprises using VPCDN achieve bandwidth savings and are able to leverage existing CDN/cloud computing datacenters and forego building out enterprise datacenters all over the world.

According to one embodiment of the invention, the system 300 includes an access module 310 is coupled to a signal module 320 via a network system(s) 380 and via a secure control channel 390. The access module 310 is also coupled to a client device 350. The network system(s) 380 may be, for example, one or more content distribution networks, cloud computing devices, and/or caches. It may also be a combination of the three or any other store and forward mechanism.

By way of example, the access module 310 may be located at the large enterprise's Paris office while the signal module 320 may be located at the Seattle office. For this illustrative example, the client user 350 located at the Paris office may send a request to the access module 310 for data. The data may be in any form, including a large file such as a video file for example. The access module 310 sends the request for data to the signal module 320. Upon receipt of the request for data, the signal module 320 encrypts the data and determines the time delay of network system(s) 380. The time delay of the network system(s) 380 may be the length of time before the access module 310 is able to start downloading the encrypted data from the network system(s) 380.

The signal module 320 then determines a start portion of the encrypted data to be sent via the secure control channel 390. The start portion of the encrypted data is the amount of encrypted data that may be transmitted over the network system(s) 380 during the time delay. For example, if the delay over the network system(s) 380 is two seconds and the data requested is 1 gigabyte in size, the signal module 320 determines how much of the 1 gigabyte data (e.g., x %) could be transmitted using the network system(s) 380 during the 2 second delay. Using that determination, the signal module 320 then transmits a start portion (x %) of the encrypted data to the access module 310 via a secure control channel 390. The signal module 320 then transmits a remainder portion (100%-x %) of the encrypted data to the access module 310 via the network system(s) 380. The remainder portion of the encrypted data is a portion equal to the encrypted data excluding the start portion (100%-x %). In one embodiment, the access module 310 may splice the start portion and the remainder portion of the encrypted data.

| Amount of data sent | Amount of data sent |
|---|---|
| over the control | through one or more |
| channel | network devices |
| x % | 100%-x % |

In one embodiment of the invention, the signal module 320 may upload the start portion of the encrypted data on the network system(s) 380. Accordingly, if, for example, another client device located at the enterprise's London office requests the same data from an access module located in London that is also coupled to the network system(s) 380, the signal module 320 may indicate to the London access module to obtain the entire encrypted data (100%) from the network system(s) 380.

In an alternative embodiment, in lieu of transmitting the remainder portion (100%-x %) of the encrypted data to the access module 310 via a single network system 380, multiple network systems 380 may be used. According to this embodiment, the remainder portion would be separated into multiple segments and each segment is transmitted via a different network system 380. This enables the remaining portion to be reduced in size to increase the speed of transfer.

### Part IV: Method of Backing Up Data on a Signal Module in a VPCDN

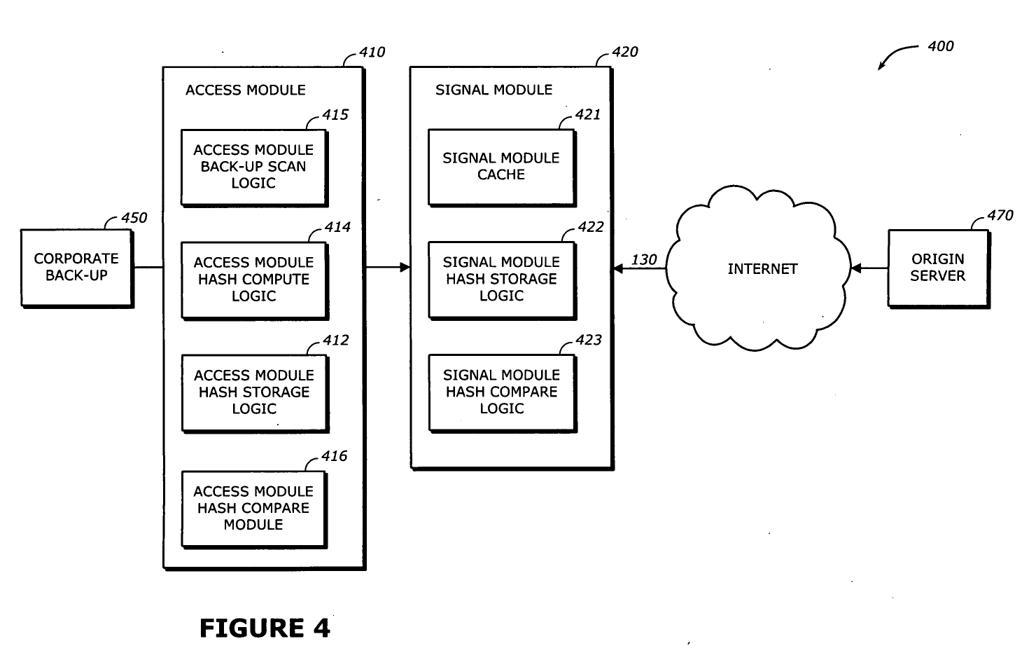

FIG. 4 shows an exemplary block diagram of a system 400 in which one embodiment of the Virtual Private Content Delivery Network (VPCDN) may be implemented to back up data.

As discussed above, data being backed up is also a significant cause of the increasing bandwidth usage and generally, half of the data being backed up consist of files downloaded from the Internet. System 400 curtails this bandwidth usage by backing up data that originates from the Internet on a signal module.

In this embodiment, a system 400 includes a corporate back-up storage device 450, an origin server 470, an access module 410, and a signal module 420. The access module 410 is coupled to the signal module 420 and to the corporate back-up storage device 450. The signal module 420 is also coupled to the origin server 470 over the Internet via a transmission medium 130 for data.

As illustrated in FIG. 4, the access module 410 includes an access module back-up scan logic 415, an access module hash compute logic 414, an access module hash storage logic 412 and an access module hash compare logic 416 and the signal module 420 includes a signal module cache 421, a signal module hash storage logic 422, and a signal module hash compare logic 423.

In one embodiment, the access module back-up scan logic 415 scans a first data being backed up by the corporate back-up storage device 450. The first data may include a first unique identification. The access module hash compute logic 414 computes a hash value of the first unique identification and the access module hash compare logic 416 compares the hash value of the first unique identification to a plurality of hash values stored in the access module hash storage logic 412.

If the hash value of the first unique identification does not match one of the plurality of stored hash values, the access module hash compare logic 416 transmits the hash value of the first unique identification to the signal module 420. Upon receipt of the hash value of the first unique identification, the signal module hash compare logic 423 compares the hash value of the first unique identification to a plurality of hash values stored in the signal module hash storage logic 422.

If the hash value of the first unique identification does not match one of the plurality of hash values stored in the signal module hash storage logic 422, the signal module hash compare logic 423 downloads the first data from the origin server 270 and stores the first data in the signal module cache 421. In one embodiment, the signal module 420 may also request and receive data information associated with the first data from the access module 410. The data information may include a filename, a time, a time accessed, and access rights of the data. The signal module 420 may also store the data information in the signal module cache 421.

If the hash value of the first unique identification matches one of the plurality of hash values stored in the signal module 420, the signal module hash compare logic 423 generates a match signal which indicates to the signal module 420 that the first data is redundant and is already backed up in the signal module cache 421 and thus, the signal module 420 does not download the first data from the origin server 270.

The above embodiments of the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a program, a procedure, etc.

An embodiment of the invention may be a machine-readable medium having stored thereon instructions which program a processor to perform some or all of the operations described above. A machine-readable medium may include any mechanism for storing or transmitting information in a form readable by a machine (e.g., a computer), such as Compact Disc Read-Only Memory (CD-ROMs), Read-Only Memory (ROMs), Random Access Memory (RAM), and Erasable Programmable Read-Only Memory (EPROM). In other embodiments, some of these operations might be performed by specific hardware components that contain hardwired logic. Those operations might alternatively be performed by any combination of programmable computer components and fixed hardware circuit components.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting. There are numerous other variations to different aspects of the invention described above, which in the interest of conciseness have not been provided in detail. Accordingly, other embodiments are within the scope of the claims.

What is claimed is:

1. A method for routing video data, comprising:
receiving a request for a video data from an electronic device;
extracting a unique identification from the video data;
computing a hash value of the unique identification;
comparing the hash value of the unique identification with a plurality of stored hash values, each of the plurality of stores hash values identifies video data that has been previously transmitted to the electronic device; and
transmitting a video display signal if the hash value of the unique identification matches one of the plurality of stored hash values, the video display signal provides information for the electronic device to locate the video data and avoid a repeated transmission of the video data.

2. The method of claim 1 further comprising:
transmitting the video data to the electronic device and storing the hash value of the unique identification if the hash value of the unique identification does not match one of the plurality of stored hash values.

3. The method of claim 2, further comprising:
storing the video data transmitted to the electronic device; and
transmitting the video data by the electronic device to a client device that is in communication with the electronic device.

4. The method of claim 1, wherein the video display signal includes the hash value of the unique identification.

5. The method of claim 4, further comprising:
upon receiving the video display signal, identifying by the electronic device a previously stored video data corresponding to the hash value of the unique identification, the previously stored video data being stored within memory accessible by the electronic device; and
transmitting by the electronic device the previously stored video data corresponding to the hash value of the unique identification to a client device.

6. The method of claim 1, wherein
the video data is in an MP4 format and
the unique identification of the video data is a MOOV atom.

7. The method of claim 6, wherein computing the hash value of the unique identification further comprises:
reordering elements in the MOOV atom; and
hashing the reordered elements.

8. The method of claim 7, wherein the elements include at least two of a start location, a frame rate, a resolution, and a key frame offset.

9. The method of claim 7, wherein reordering the elements in the MOOV atom comprises:
reordering the elements in alphabetical order.

10. The method of claim 1, further comprising:
receiving a flush signal from the electronic device, the flush signal including a flush hash, the flush hash being a hash value of the unique identification of a video data being deleted from internal memory within the electronic device; and
deleting a hash value corresponding to the flush hash from the plurality of stored hash values.

11. A method for efficiently routing video data from a signal module, comprising:
transmitting a request for a video data to the signal module;
receiving the video data from the signal module;
extracting a unique identification of the video data,
computing a hash value of the unique identification;
comparing the hash value of the unique identification with a plurality of stored hash values; and
transmitting a stop transmission signal to the signal module if the hash value of the unique identification matches one of the plurality of stored hash values, the stop transmission signal signals to the signal module to stop transmitting the video data since the video data is currently stored within the access module.

12. The method of claim 11 further comprising:
identifying a previously stored video data corresponding to the video data by comparing a hash value associated with the previously stored video data with the hash value of the unique identification; and
transmitting the previously stored video data to a requesting client device.

13. The method of claim 11, further comprising:
storing the video data received from the signal module if the hash value of the unique identification fails to match any of the plurality of stored hash values; and
transmitting the video data received from the signal module to a requesting client device.

14. The method of claim 11, further comprising:
storing the video data at the signal module.

15. The method of claim 11, wherein
the video data is in an MP4 format and
the unique identification of the data is a MOOV atom.

16. The method of claim 15, wherein computing the hash value of the unique identification further comprises:
reordering elements in the MOOV atom; and
hashing the reordered elements.

17. The method of claim 16, wherein the elements include at least two of a start location, a frame rate, a resolution, and a key frame offset.

18. A system comprising:
a signal module to receive a requested video data having a unique identification from an origin server, the signal module including:
a SM hash compute module to compute a hash value of the unique identification of the requested video data,
a SM cache to store a plurality of previously requested video data,
a SM hash storage module to store hash values of the unique identifications of the previously requested video data stored in the SM cache, and
a SM hash compare module
to compare the hash value of the unique identification of the requested video data to the hash values stored in the SM hash storage module, and
to generate a transmit signal if the hash value of the unique identification of the requested video data does not match one of the hash values stored in the SM hash storage module; and
a cache module coupled to the signal module, the cache module including
a CM cache to store the requested video data and previously requested video data received from the signal module,
a CM hash compute module to compute the hash values of the unique identification of requested video data and the previously requested video data stored in the CM cache, and
a CM hash storage to store the hash values computed in the CM hash compute module.

19. The system of claim 18, wherein
the signal module transmits the requested video data to the cache module upon receipt of the transmit signal.

20. A system comprising:
a plurality of clients including a first client and a second client, the first client sending a request for a first requested video data and the second client sending a request for a second requested video data, the first and second requested video data each having a unique identification; and
a cache module (CM) receiving the requests from the first and second clients and receiving the first and a second requested video data from an external source, the cache module including:
a CM cache to store a plurality of previously requested video data, each of the plurality of previously requested video data having unique identifications,
a CM hash storage to store hash values of the unique identifications of the plurality of previously requested video data,
a CM hash compute module to compute a first hash value, the first hash value being a hash value of the unique identification of first requested video data,
a CM hash compare module
to compare the first hash value to the hash values stored in the CM hash storage and
to generate a transmit signal if the first hash value does not match one of the hash values stored in the CM hash storage module, and
a CM stream sampling compare module to perform a comparison operation and generating a stop signal if the comparison operation indicates a match at a number of entry points, the comparison operation includes:
hashing headers of the first requested video data and the second requested video data at a number of entry points to obtain a number of hash results for the first requested video data and a number of hash results for the second requested video data,
comparing for each of the number of entry points hash result for the first requested video data to the corresponding hash result for the second requested video data, and
determining if there is a match between the hash results at each of the number of entry points.

21. The system of claim 20, wherein
the first requested video data is in a FLV format, the video data including a script tag with indexing information, and
the unique identification of the first requested video data is the first indexing information.

22. The system of claim 20, wherein
the first requested video data is in a RTSP format, and
the unique identification of the data is an ASF header and GUID, the ASF header and GUID being included in the video data.

23. The system of claim 20, wherein
the first requested video data is in a RTMP format, and
the unique identification of the data is the header included in the video data.
